(19) United States
(12) Patent Application Publication
(10) Pub. No.: US 2016/0084088 A1
(43) Pub. Date: Mar. 24, 2016

(54) STRESS RELIEVING FEATURE IN GAS TURBINE BLADE PLATFORM

(71) Applicant: SIEMENS ENERGY, INC., Orlando, FL (US)

(72) Inventors: Charles M. Evans, Tequesta, FL (US); Andrew R. Narcus, Loxahatchee, FL (US)

(73) Assignee: SIEMENS ENERGY, INC., Orlando, FL (US)

(21) Appl. No.: 14/890,619

(22) PCT Filed: May 20, 2014
(86) PCT No.: PCT/US14/38724

§ 371 Date: Nov. 12, 2015

Related U.S. Application Data
(60) Provisional application No. 61/825,597, filed on May 21, 2013.

(51) Int. Cl. F01D 5/14

(52) U.S. Cl. CPC F01D 5/141; F05D 2220/32

(57) ABSTRACT

A gas turbine engine blade (10) having: an airfoil (12) having a leading edge (14), a trailing edge (16), a pressure side (22), and a suction side (24); an inner platform (30) associated with a base (18) of the airfoil, wherein the inner platform includes a platform aft face (34) spanning between an platform pressure side face (36) and a platform suction side face (38); and a trailing edge undercut (70) across the aft face. The trailing edge undercut tapers to zero penetration before reaching the platform suction side face. In a side cross section, a leading portion (100) of the trailing edge undercut is defined by a leading radius (102), an upper portion (104) is defined by an upper radius (106), and a lower portion (108) is defined by a lower radius (110). For at least one location along the aft face, values for all three radii are distinct.

This application claims benefit of the 21 May 2013 filing date of U.S. provisional patent application No. 61/825,597, which is incorporated by reference herein.

### FIELD OF THE INVENTION

The invention relates to a gas turbine engine blade having a stress relieving feature formed in the inner platform to relieve stress formed in a trailing edge region of the blade where the airfoil and inner platform meet.

### BACKGROUND OF THE INVENTION

Gas turbine engines impart rotation to a shaft by combusting fuel and directing hot gases onto turbine blades affixed to the shaft. The hot gases impart mechanical force and thermal energy to the blades, which produces mechanical and thermal stresses within the blade. Thermal stresses may concentrate in regions of the blade where local areas respond differently to the temperature changes. For example, a trailing edge of an airfoil portion of the blade is one of the thinnest areas of the blade. Consequently, it responds (i.e. expands and contracts) relatively more quickly to changes in temperature than, for example, an inner platform with which it interfaces. In addition to this type of thermo-mechanical fatigue, rotating blades are subject to cycling mechanical loads from normal engine operation. For example, stationary vanes alter the fluid dynamics of the flowing hot gases, and so a blade that rotates behind stationary vanes experiences varying mechanical loads from the hot gases. Due to the geometry of the blade, these varying mechanical loads may also concentrate where the trailing edge of the airfoil portion and the inner platform interface. For at least these reasons, this trailing edge region is susceptible to crack initiation which may ultimately lead to blade failure.

As technology improves and as gas turbine engines are being manufactured to different standards, conditions in which the blade operate change. In addition, an understanding of the operating environment grows with better modeling etc. Together, these provide room for continued improvements in the art.

### BRIEF DESCRIPTION OF THE DRAWINGS

The invention is explained in the following description in view of the drawings that show:

FIG. 1 is a perspective view of a blade having an exemplary embodiment of a trailing edge undercut.

FIG. 2 is another perspective view of the trailing edge undercut of FIG. 1.

FIG. 3 is another perspective view of the trailing edge undercut of FIG. 1.

FIG. 4 is a top view of the blade of FIG. 1 showing locations for various cross sectional views of the trailing edge undercut of FIG. 1.

FIGS. 5-7 are cross sectional views at the locations shown in FIG. 4 of the trailing edge undercut of FIG. 1.

FIG. 8 is a cross sectional view of an alternate exemplary embodiment of the trailing edge undercut of FIG. 1.

### DETAILED DESCRIPTION OF THE INVENTION

The present inventors have created a stress relieving trailing edge undercut that is effective to reduce thermal and mechanical stresses generated in a region of a gas turbine engine blade where a trailing edge of the airfoil meets an inner platform. The unique trailing edge undercut is characterized in a cross sectional view by three distinct portions, each conforming to a radius. The undercut spans less than an entire width of an aft surface of the inner platform. This configuration is effective to reduce stress in the trailing edge region, yet permit the blade to operate as originally intended. Another reason that the undercut does not span the entire width of the platform TE is that an undercut can produce a region of higher temperature on the aft platform surface due to increased heat transfer created by the undercut feature in this region. Therefore, minimizing a size of the undercut minimizes the increased heat transfer. The trailing edge undercut can be formed when the blade is cast, or subsequently machined into the blade.

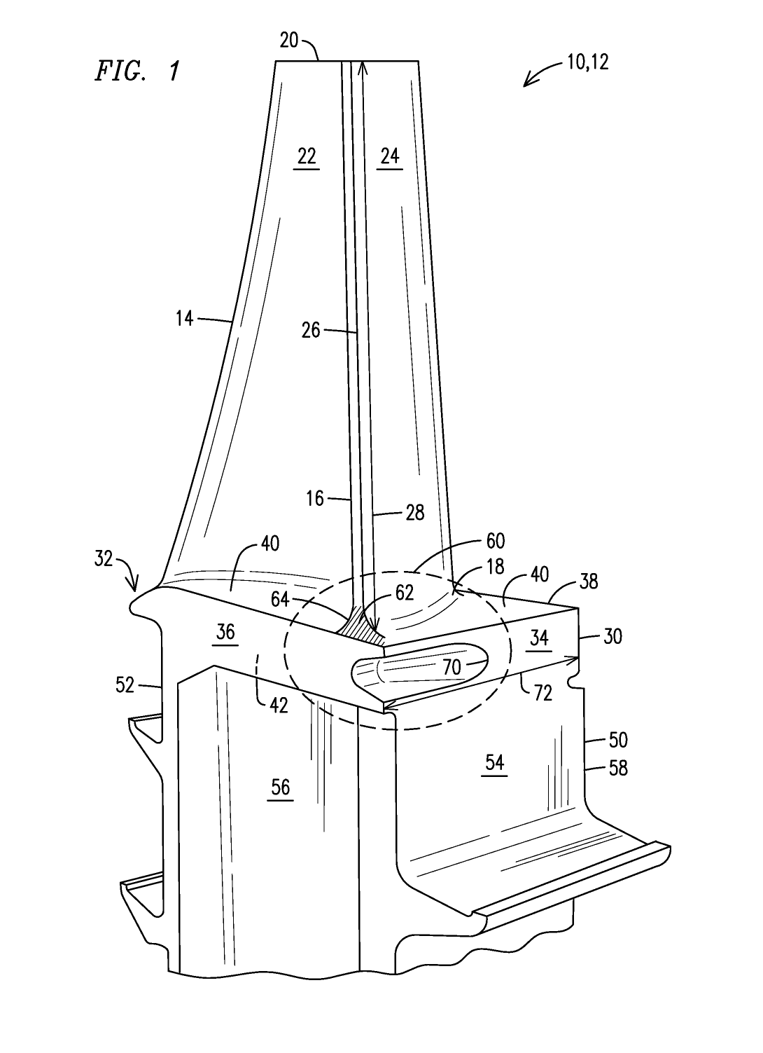

FIG. 1 shows a gas turbine engine blade 10 having an airfoil 12 with a leading edge 14, a trailing edge 16, a base 18, a tip 20, a pressure side 22, and a suction side 24. The trailing edge 16 is trailing edge line 26 that is essentially radially oriented and formed by connected a series of points, where each point lies between the pressure side 22 and the suction side 34 at a given location along a radial length 28 of the airfoil 12. The airfoil 12 is secured to an inner platform 30 having a platform forward face 32, a platform aft face 34, a platform pressure side face 36, a platform suction side face 38, a platform gas path surface 40 and a platform coolant surface 42. The inner platform 30 lies between the airfoil 12 and a shank 50, which has a shank forward face 52, a shank aft face 54, a shank pressure side face 56, and a shank suction side face 58.

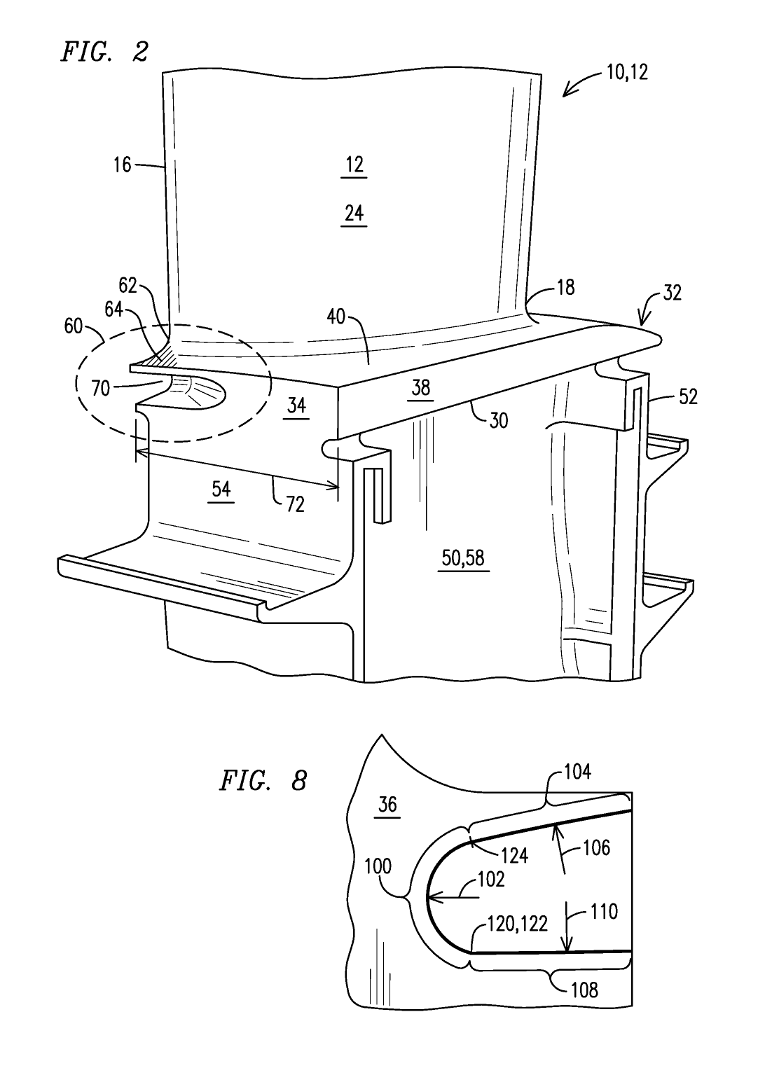

A trailing edge region 60 is generally indicated by the dotted line and includes an interface 62 between the trailing edge 16 of the airfoil 12 and the inner platform 30. As used herein the interface includes the trailing edge 16 and any geometric feature that transfers stress between the trailing edge 16 and the inner platform 30. In this exemplary embodiment the geometric feature includes fillets 64 surrounding the trailing edge 16 and blending the trailing edge 16 into the inner platform. The trailing edge region 60 includes a local volume of the airfoil 12 and inner platform 30 that experience increased stresses due to the interface 62. The trailing edge undercut 70 is formed into the inner platform 30, across the platform aft face 34 between the platform pressure side face 36 and the platform suction side face 38, but not spanning an entire width 72 of the platform aft face 34. In the exemplary embodiment shown, the trailing edge undercut 70 spans from the platform pressure side face 36 approximately half of the width 72 of the platform aft face 34. As used herein, approximately means +/−0.250 inches of a midpoint of the width 72. FIG. 2 shows a different view of the blade 10 of FIG. 1.

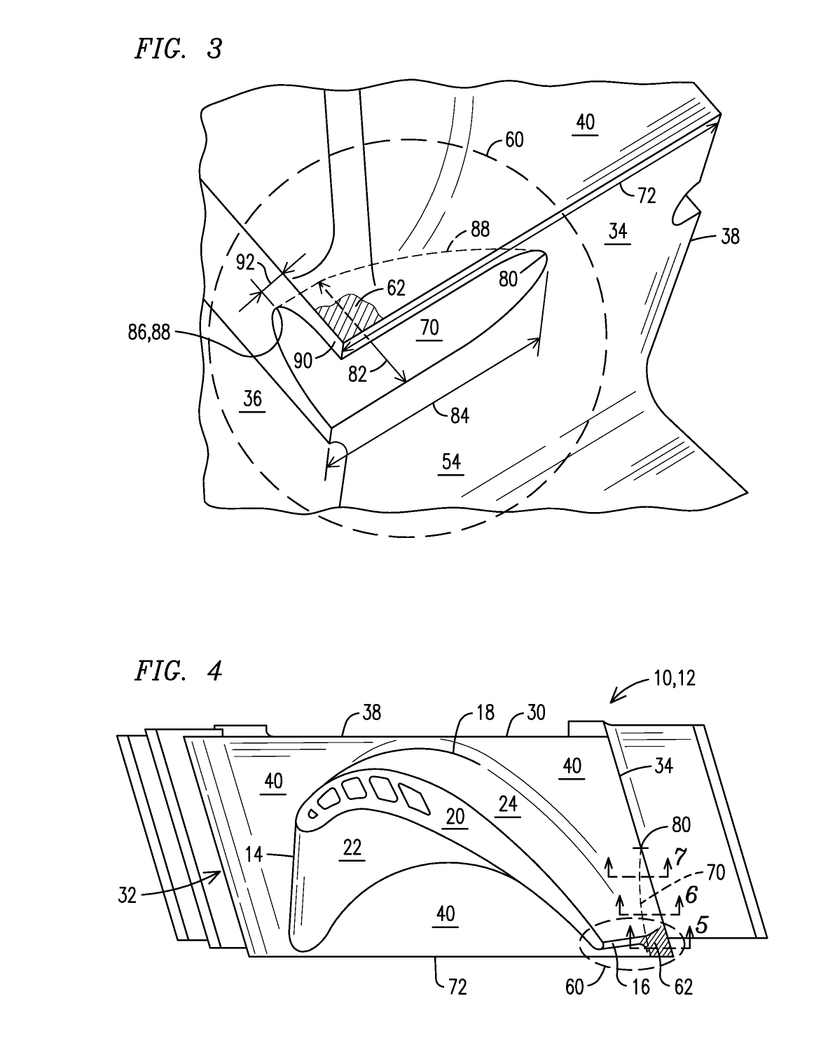

As can be seen in FIG. 3, which shows parts of the blade 10, some of which are shown as transparent, the trailing edge undercut 70 tapers to an opposite end 80 approximately half way between the platform pressure side face 36 and the platform suction side face 38. At any given cross section taken parallel to the platform pressure side face 36 the trailing edge undercut may include a leading edge point 86, which is the forward most point of the trailing edge undercut 70 for the given cross section, i.e. closest to the platform forward face 32. A leading edge line 88 is formed by a line connecting leading edge points 86. A depth 82 of any given point of the trailing edge undercut 70 along the shank aft face 54 is characterized by a distance from the shank aft face 54 to a respective leading edge point 86. In the exemplary embodiment of FIG. 3, it can be seen that the leading edge line 88 tapers toward the platform forward face 32 as the trailing edge undercut 70 nears the platform suction side face 38. It may vary linearly, non linearly, or a combination of linearly and non linearly. Further, the taper may increase the depth 82 before decreasing the depth 82 to zero at the opposite end 80. A length 84 of the trailing edge undercut 70 shown is a distance from the platform pressure side face 36 to the opposite end 80.

The trailing edge 16 of the airfoil is not shown, but the interface 62 is indicated for clarity. The trailing edge undercut 70 extends forward to a depth 82 sufficient to place the some of the trailing edge undercut 70 under and forward of the interface 62. Stated another way, the leading edge line 88 passes forward of where the trailing edge 16 would be if it continued past the interface 62. The result of this configuration is that the interface 62 occurs on a cantilevered portion 90 of the inner platform 30, where the cantilevered portion 90 is formed by the trailing edge undercut 70. The depth 82 may put the leading edge line 88 slightly forward of the interface 62, or much farther forward of the interface 62.

Through this configuration the trailing edge undercut 70 extends past a stress line during operation, which is essentially an extension of the trailing edge line 26 through the inner platform 30. In operation, the trailing edge undercut 70 interrupts the stresses and reroutes them. This permits most, if not all of the interface 62 (depending on the exact configuration) to move since at least part of it rests on a cantilevered section of the inner platform 30. This softening allows for minute displacement of the airfoil trailing edge 16 caused by thermal and mechanical loads. This, in turn, reduces that stress associated with these loads, which extends the life of the blade. The leading edge line 88 may be disposed at a constant distance 92 from a contour defined by the platform gas path surface 40 away from the airfoil 12. In other words, the leading edge line 88 may be disposed at a substantially constant distance 92 from a shape the platform gas path surface 40 would take without the airfoil 12 and without the fillets that blend the airfoil 12 with the platform gas path surface 40. As used herein, substantially means that the magnitude of the distance 92 may vary +/−0.25 inches along the length 84. Stated another way, a smallest and a largest distance may be within 0.050 inches of each other.

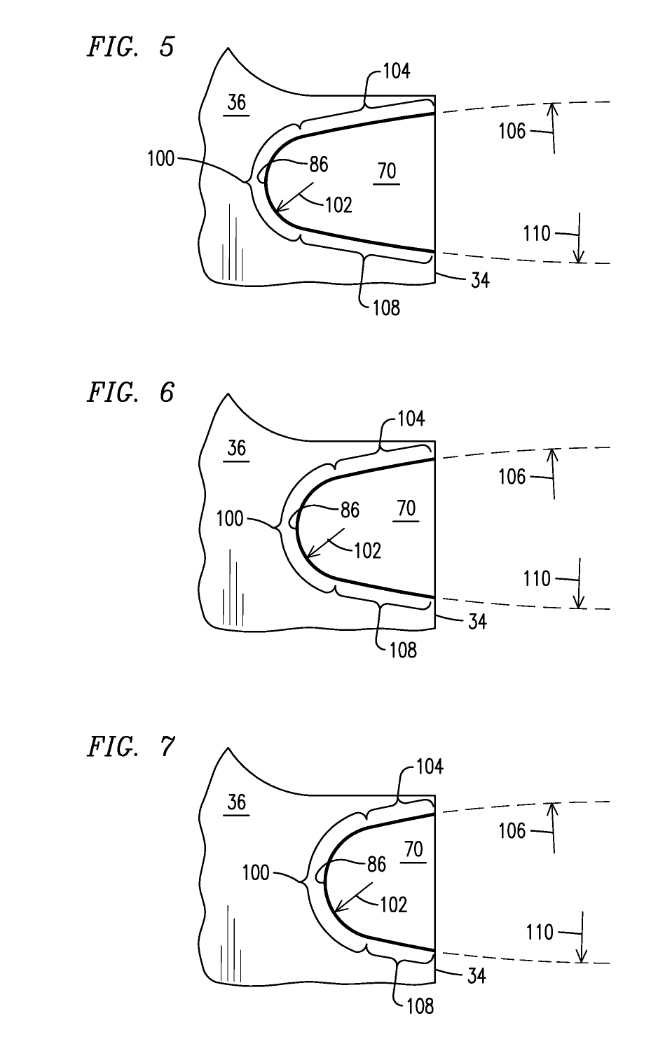

FIG. 4 is a top view of the blade of FIG. 1 showing locations for various cross sectional views of the trailing edge undercut of FIG. 1. The first location 5-5 is at the platform pressure side face 36, the second location 6-6 is a location half way between the first location 5-5 and a third location 7-7 closest of the three locations to the opposite end 80. FIGS. 5-7 are cross sectional views at the locations shown in FIG. 4 of the trailing edge undercut 70 of FIG. 1.

FIG. 5 is a side cross section taken at the platform pressure side face 36, which is effectively a side view of the trailing edge undercut 70. In each cross sectional view the trailing edge undercut 70 is characterized by a leading portion 100 having a shape conforming to a leading radius 102, an upper portion 104 having a shape conforming to an upper radius 106, and a lower portion 108 having a shape conforming to a lower radius 110.

In FIGS. 5-7 a nominal value of the leading radius is 0.128 inches, 0.124 inches, and 0.124 inches respectively, a nominal value of the upper radius is 10.486 inches, 10.505 inches, and 12.66 inches respectively, and a nominal value of the lower radius is 9.890 inches, 9.877 inches, and 13.943 inches respectively. A nominal value is a design goal and includes a tolerance of +/−0.005 inches. In all embodiments a value of the upper radius 106 and a value of the lower radius 110 are substantially greater than a value of the leading radius 102, where substantially greater means at least thirty times greater. Each radius value may be distinct from the others for at least one point along the length 84 of the trailing edge undercut 70. In an exemplary embodiment each radius value may be distinct from the others for all locations along the length 84. In an exemplary embodiment, for at least one location along the length 84 the upper radius value and the lower radius value may be the same as each other but different than the leading radius value. In an alternate exemplary embodiment, for all locations along the length 84 the upper radius value and the lower radius value may be the same as each other but different than the leading radius value. In an alternate exemplary embodiment the upper radius value and the lower radius value are both at least fifty times greater than the leading radius value for at least one location along the length 84. In the exemplary embodiment of FIGS. 5-7 the upper radius value and the lower radius value are both at least fifty times greater than the leading radius value for all locations along the length 84.

For all locations along the platform aft face 34 values for the leading radii all fall within +/− five percent of a leading radius value at a given location along the platform aft face 34. In an exemplary embodiment, all of the leading radii values fall within +/− five percent of the leading radius value at the platform pressure side face 36, and the value for the leading radius 102 changes along the platform pressure side face 36.

For all locations along the platform aft face 34 the upper radii values all fall within +/− twenty percent of an upper radius value at a given location along the platform aft face 34. In an exemplary embodiment, all of the upper radii values fall within +/− twenty percent of the upper radius value at the platform pressure side face 36, and the value for the upper radius 106 changes along the platform pressure side face 36.

For all locations along the platform aft face 34 the lower radii values all fall within +/− forty percent of a lower radius value at a given location along the platform aft face 34. In an exemplary embodiment, all of the lower radii values fall within +/− forty percent of the lower radius value at the platform pressure side face 36, and the value for the lower radius 110 changes along the platform pressure side face 36.

FIG. 8 shows an alternate exemplary embodiment where the leading portion 100 and the lower portion 108 are not smoothly blended, but instead form a non smooth transition such as a groove 120 at a lower transition 122 between the leading portion 100 and the lower portion 108. Alternately, or in addition, there may be a non smooth transition at an upper transition 124 between the leading portion 100 and the upper portion 104.

The trailing edge undercut 70 described herein presents a unique configuration for reducing trailing edge stresses and thus represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A gas turbine engine blade, comprising:
an airfoil comprising a leading edge, a trailing edge, a pressure side, and a suction side;
an inner platform associated with a base of the airfoil, wherein the inner platform comprises a platform aft face spanning between an platform pressure side face and an platform suction side face; and
a trailing edge undercut across the platform aft face,
wherein the trailing edge undercut tapers to zero penetration before reaching the platform suction side face,
wherein for any location along the platform aft face, in a side cross section, a leading portion of the trailing edge undercut is defined by a leading radius, an upper portion is defined by an upper radius, and a lower portion is defined by a lower radius, and
wherein for at least one location along the platform aft face, values for all three radii are distinct.

2. The gas turbine engine blade of claim 1, wherein the trailing edge undercut extends to the platform pressure side face.

3. The gas turbine engine blade of claim 2, wherein the trailing edge undercut spans approximately one half of a width of the platform aft face.

4. The gas turbine engine blade of claim 1, wherein in at least one location along the platform aft face a portion of the trailing edge undercut is disposed forward of the trailing edge of the airfoil.

5. The gas turbine engine blade of claim 1, wherein for at least a portion of a length of the trailing edge undercut along the platform aft face a depth of the trailing edge undercut from the platform aft face varies non linearly.

6. The gas turbine engine blade of claim 1, wherein at all locations along the platform aft face a leading edge of the leading portion remains at a substantially constant distance from a contour defined by an gas path surface of the inner platform.

7. The gas turbine engine blade of claim 1, wherein all values for the leading radii fall within +/− five percent of a value of a leading radius at a given location along the platform pressure side face.

8. The gas turbine engine blade of claim 7, wherein for all locations along the platform aft face a value of the leading radius is within five percent of a value of the leading radius at the platform pressure side face, and wherein at a location along the platform aft face a value of the leading radius is different than the value of the leading radius at the platform pressure side face.

9. The gas turbine engine blade of claim 8, wherein the value of the leading radius at the platform pressure side face is 0.128 inches +/−0.005 inches.

10. The gas turbine engine blade of claim 1, wherein for any given location along the platform aft face a value of the upper radius and a value of the lower radius are both at least fifty times greater than a value of the leading radius at the given location.

11. The gas turbine engine blade of claim 10, wherein for all locations along the platform aft face a value of the upper radius is within twenty five percent of a value of the upper radius at the platform pressure side face, and wherein at a location along the platform aft face a value of the upper radius is different than the value of the upper radius at the platform pressure side face.

12. The gas turbine engine blade of claim 11, wherein the value of the upper radius at the platform pressure side face is 10.486 inches +/−0.005 inches.

13. The gas turbine engine blade of claim 10, wherein for all locations along the platform aft face the value of the lower radius is within forty five percent of a value of the lower radius at the platform pressure side face, and wherein for a location along the platform aft face a value of the lower radius is different than the value of the lower radius at the platform pressure side face.

14. The gas turbine engine blade of claim 13, wherein the value of the lower radius at the platform pressure side face is 9.890 inches +/−0.005 inches.

15. The gas turbine engine blade of claim 1, wherein in at least one location along the platform aft face at least one of an upper transition between the leading radius and the upper radius and a lower transition between the leading radius and the lower radius comprises a step or groove formed there between.

16. A gas turbine engine comprising the gas turbine engine blade of claim 1.

17. A gas turbine engine blade, comprising:
an inner platform associated with a base of an airfoil, wherein the inner platform comprises a platform aft face spanning between an platform pressure side face and an platform suction side face; and
a trailing edge undercut across the platform aft face extending from the platform pressure side face approximately half way to the platform suction side face,
wherein the trailing edge undercut extends under a trailing edge of the airfoil;
wherein for at least one location along the platform aft face in a side cross section the trailing edge undercut is characterized by three radii, each having a distinct value.

18. The gas turbine engine blade of claim 17, wherein at any given location along the platform aft face a leading portion of the trailing edge is defined by a leading radius, an upper portion is defined by an upper radius, and a lower portion is defined by a lower radius, and wherein at the given location a value of the upper radius and a value of the lower radius are each at least fifty times a value of the leading radius.
